(19) United States
(12) Patent Application Publication
(10) Pub. No.: US 2003/0168352 A1
(43) Pub. Date: Sep. 11, 2003

(54) Measurement of trivalent iron cation concentrations

(76) Inventors: Salman S Almutawali, farmington Hills, MI (US); Lawrence E Faw, Walled Lake, MI (US); Norvell E Wisdom, Longview, TX (US)

Correspondence Address: HENKEL CORPORATION, 2500 RENAISSANCE BLVD, STE 200, GULPH MILLS, PA, 19406, US

(21) Appl. No.: 10/257,786

(22) PCT Filed: Apr. 19, 2001
(86) PCT No.: PCT/US01/12717

(30) Foreign Application Priority Data
Apr. 19, 2000 (US) 60198304

(51) Int. Cl. C02F 1/461

(52) U.S. Cl. 205/742

(57) ABSTRACT

A process for eliminating the interference of peroxide in an analysis of the concentration of iron(III) with which the presence of peroxide interferes. The process has the following steps: (I) providing an aqueous liquid analyte that contains both dissolved iron(III) and dissolved peroxide, the concentration of peroxide in the aqueous liquid analyte being sufficient to interfere with the determination of iron(III); (II) bringing the analyte into contact with an electrode; (III) causing electrical current to flow; and (IV) continuing the current flow until the concentration of peroxide in the analyte has been reduced to a sufficiently low value that it no longer interferes with determining the concentration of iron(III) in the analyte, thereby forming a peroxide-depleted analyte.

### BACKGROUND OF THE INVENTION

1. Field of the Invention

This invention relates to industrial processes for brightening and pickling substrates, such as stainless steel substrates. In such processes, it is desirable to know the concentration of trivalent iron cations for improving process control.

2. Background Art

In various industrial applications, it is important to control, and therefore necessary to be able to measure, concentrations of both peroxide and trivalent iron cations in process solutions. Both peroxide and iron(III) are oxidizing agents compared to most other chemical substances, so that the concentration of either of them when present in the absence of other oxidizing agents can be readily determined by titrations with various reducing agents, and the concentration of peroxide can also be determined by titration with oxidizing agents, as is known to those skilled in the art. When both peroxide and iron(III) are present, however, accurate determination of iron concentrations by redox titration becomes difficult, at least in part because of the possibility for peroxide to act as either a reducing or an oxidizing agent. The difficulty in accurate determination of iron(III) has been found to be particularly apparent when the iron(III) concentration is considerably smaller than the peroxide concentration. This situation prevails in some embodiments of pickling and/or brightening processes as taught in one or more of U.S. Pat. No. 5,354,383 of Oct. 11, 1994 to Bianchi and U.S. Pat. No. 5,417,775 of May 23, 1995 to Pedrazzini and in U.S. International Application PCT/US98/26235 (published as WO 99/32690 on Jul. 1, 1999), the entire disclosures of all of which, to the extent not inconsistent with any explicit statement herein, are hereby incorporated herein by reference. This invention is particularly applicable to pickling and/or brightening solutions as described in these incorporations by reference.

A major object of the present invention is to provide a satisfactory method for the accurate determination of concentrations of iron(III) in analytical samples that also contain peroxide in a higher concentration than the iron(III), without requiring the use of high capital cost methods such as atomic absorption spectroscopy. Other alternative, subordinate, and/or more detailed objects will become apparent from the description below.

Except in the claims and the operating examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred, however. Also, throughout the description, unless expressly stated to the contrary: percent, “parts of”, and ratio values are by weight or mass; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description or of generation in situ within the composition by chemical reaction(s) noted in the specification between one or more newly added constituents and one or more constituents already present in the composition when the other constituents are added, and does not necessarily preclude unspecified chemical interactions among the constituents of a mixture once mixed; specification of constituents in ionic form additionally implies the presence of sufficient counterions to produce electrical neutrality for the composition as a whole and for any substance added to the composition; any counterions thus implicitly specified preferably are selected from among other constituents explicitly specified in ionic form, to the extent possible; otherwise such counterions may be freely selected, except for avoiding counterions that act adversely to an object of the invention; and the terms “solution”, “soluble”, “homogeneous”, and the like are to be understood as including not only true equilibrium solutions or homogeneity but also dispersions that show no visually detectable tendency toward phase separation over a period of observation of at least 100, or preferably at least 1000, hours during which the material is mechanically undisturbed and the temperature of the material is maintained within the range of 18-25° C.

### SUMMARY OF THE INVENTION

The present invention discloses a process for eliminating the interference of peroxide in an analysis of the concentration of iron(III) with which the presence of peroxide interferes. The process has the following steps: providing an aqueous liquid analyte that contains both dissolved iron(III) and dissolved peroxide, the concentration of peroxide being sufficient to interfere with the determination of iron(III); bringing the analyte into contact with an electrode; causing electrical current to flow; and continuing the current flow until the concentration of peroxide in the analyte has been reduced to a sufficiently low value that it no longer interferes with determining the concentration of iron(III), thereby forming a peroxide-depleted analyte.

### DETAILED DESCRIPTION OF THE PREFERRED EMBODIMENTS

The invention discloses a process for eliminating the interference of peroxide in an analysis of the concentration of iron(III), within a selected accuracy value and by a selected method, with which the presence of peroxide interferes. The process comprises the following steps:

(I) providing an aqueous liquid primary analyte that contains both dissolved iron(III) and dissolved peroxide, the concentration of peroxide in the aqueous liquid analyte being sufficient to interfere with the determination of iron(III) within the selected accuracy value by the selected method;

(II) bringing the primary analyte provided in step (I) (optionally after mixing it with one or more other substances that either contain no peroxide or iron(III) or contain accurately and separately known amounts of at least one of peroxide and iron(III) to form a secondary analyte) into contact with one of two distinct electrodes;

(III) causing direct electrical current to flow successively through one of the distinct electrodes that is in contact with the primary analyte or the secondary analyte in an anodizing direction, through the primary analyte or the secondary analyte, optionally through a diffusion barrier and a distinct liquid electrolyte that is in contact with one of the distinct electrodes with which the primary analyte or the secondary analyte is not in contact and that is separated from the primary or the secondary analyte by the diffusion barrier, and out of the primary analyte, the secondary analyte, or the distinct liquid electrolyte in a cathodizing direction through one other of the distinct electrodes; and

(IV) continuing the current flow caused in step (III), optionally with one or more interruptions, until the concentration of peroxide in the primary analyte or the secondary analyte has been reduced to a sufficiently low value that it no longer interferes with determining the concentration of iron(III) in the primary analyte or the secondary analyte by the selected method within the selected accuracy value, thereby forming a peroxide-depleted primary analyte or secondary analyte.

This sequence of steps implies that a method of analysis for peroxide is available in order to determine when step (IV) has been completed. Such methods of analysis for peroxide are known to those skilled in the art. One convenient and preferred but not limiting such method is shown in the examples herein.

If the only available electrical direct current for use in a process according to the invention is from batteries or some other relatively expensive source, while chemical analysis of peroxide is cheaply and readily available, it will usually be advantageous to interrupt the current frequently in step (IV) and determine the peroxide concentration on a sample of the electrolyzed primary analyte or secondary analyte after each such interruption, so that the consumption of electrical energy may be minimized. This also allows for the possibility that autodecomposition of the peroxide by chemical reactions that do not require the imposition of electric current from an outside source is occurring during electrolysis to a sufficient extent to reduce the amount of electrical energy input required.

However, under most conditions where an analysis of iron(III) concentration is needed in practice, a relatively inexpensive source of direct electrical current will be or can cheaply be made available by use of rectified commercially supplied alternating electric current. Under such conditions, a considerable amount of electrical energy in the form of direct current at a suitable voltage can cost less than a single chemical analysis for peroxide. Under such conditions, it is normally preferred to measure (or otherwise determine, as by calculation from the characteristics of materials used to make the primary analyte) the actual peroxide concentration or an upper limit for the actual peroxide concentration only once, on the initial primary analyte. When a secondary analyte as described above is used, the concentration or amount of peroxide in the secondary analyte is calculated from the known dilution factor by which primary analyte is converted to secondary analyte and from any peroxide that may be added during preparation of the secondary analyte. If an upper limit amount or concentration of peroxide in the primary analyte or secondary analyte to be electrolyzed is thus known, it has been found reliable and less expensive to utilize a preferred embodiment of the invention in which:

an upper limit on the concentration of peroxide in the primary analyte or secondary analyte electrolyzed in steps (III) and (IV) is known before beginning the electrolysis; and

the current flow caused in step (III) is continued in step (IV) until an integral of a function of the amount of current flowing through the primary analyte or the secondary analyte against time (the integral being measured between the times of beginning and discontinuing the current flow) has reached at least a certain value. That value corresponds to complete electrolytic consumption of the known upper limit content of peroxide in the primary analyte or the secondary analyte by oxidizing the oxygen content of the peroxide to elemental oxygen, thereby forming a peroxide-depleted and interference-free primary analyte or secondary analyte.

The amount of electrical charge needed to electrolytically destroy the entire upper limit amount of peroxide present in the primary analyte or secondary analyte electrolyzed can be determined by mutiplying the Faraday constant of 9.65×10⁴ coulombs per equivalent by twice the number of moles of peroxide present in the analyte or secondary analyte electrolyzed. (The coulombs for this value of the Faraday constant are “practical” coulombs, each equal to 0.1 absolute electromagnetic coulombs. The factor “twice” arises because each molecule of peroxide requires two electrons to oxidize its oxygen content to elemental oxygen, so that there are two electrochemical equivalents of hydrogen peroxide per mole.)

A process according to the invention as described above for removing the interference of peroxide may be extended to a process according to the invention for the actual analytical determination of iron(III) by appending to steps (I) through (IV) as described above a step (V) as follows:

(V) determining the amount of iron(III) in the peroxide-depleted primary analyte or secondary analyte produced in step (IV) by the selected analytical method within the selected accuracy value.

In a preferred analytical determination, the amount of iron(III) is determined in step (V) by direct titration for iron(III). Alternatively, the amount of iron(III) is found by determining the concentration of a product chemical substance that has been produced by a reaction that generates the product chemical substance in a known quantitative ratio between the concentration of iron(III) present before reaction and the concentration of the product chemical substance after reaction, by titration with a solution of known concentration of a reducing agent for iron(III) or for the product chemical substance if the latter is present. The concentration of iron(III) in the original analyte provided in step (I) can then be determined, as is known to those skilled in the art, by an arithmetic calculation that takes account of any dilution and any addition of iron(III) that occurred during the preparation of the peroxide-depleted analyte.

A process of analysis according to the invention is preferably applied to a primary analyte that has at least one of the following characteristics:

(A) a concentration of peroxide, measured as its stoichiometric equivalent as hydrogen peroxide, that is at least, with increasing preference in the order given, 5, 10, 15, 20, 25, 30, 35, or 39 grams of hydrogen peroxide per liter of primary analyte (this unit of concentration being hereinafter applied to any constituent in any homogeneous liquid and being hereinafter usually abbreviated as “g/l”). This concentration of peroxide is measured as being not more than, with increasing preference in the order given, 300, 200, 150, 100, 75, 65, 55, 50, 45, or 41 g/l;

(B) a concentration of iron(III) that is at least, with increasing preference in the order given, 0.5, 1.0, 2.0, 3.0, 3.5, 4.0, 4.5, or 4.9 g/l and preferably is not more than, with increasing preference in the order given, 50, 40, 30, 25, 20, 17, 14, 12, 10, or 8 g/l;

(C) a ratio of the concentration of the stoichiometric equivalent as hydrogen peroxide of the total peroxide in the analyte to the concentration of iron(III) in the same analyte that is at least, with increasing preference in the order given, 1.0:1.00, 2.0:1.00, 3.0:1.00, 4.0:1.00, 4.5:1.00, 5.0:1.00, 5.5:1.00, 6.0:1.00, 6.5:1.00, 7.0:1.00, 7.5:1.00, or 7.9:1.00 and preferably is not more than, with increasing preference in the order given, 100:1.00, 80:1.00, 60:1.00, 40:1.00, 30:1.00, 20:1.00, 15:1.00, 12:1.00, 10.0:1.00, 9.5:1.00, 9.0:1.00, 8.5:1.00, or 8.1:1.00;

(D) a concentration of dissolved fluoride ions, measured as their stoichiometric equivalent as hydrofluoric acid, that is at least, with increasing preference in the order given, 1.0, 2.0, 3.0, 4.0, 4.5, 5.0, 5.5, 6.0, 6.5, or 6.9 g/l and preferably is not more than, with increasing preference in the order given, 50, 40, 30, 20, 15, 13, 11, 9, or 7 g/l;

(E) a ratio of the concentration in g/l of dissolved fluoride ions, measured as their stoichiometric equivalent as hydrofluoric acid, to the concentration of iron(III) that is at least, with increasing preference in the order given, 0.3:1.00, 0.5:1.00, 0.7:1.00, 0.9:1.00, 1.10:1.00, 1.20:1.00, 1.25:1.00, 1.30:1.00, 1.35:1.00, or 1.39:1.00 and preferably is not more than, with increasing preference in the order given, 7.0:1.00, 5.0:1.00, 4.0:1.00, 3.5:1.00, 3.0:1.00, 2.5:1.00, or 2.3:1.00; and

(F) a concentration of sulfuric acid that is at least, with increasing preference in the order given, 5, 10, 15, 20, 25, 30, 35, or 39 g/l and preferably is not more than, with increasing preference in the order given, 500, 400, 300, 250, 200, 150, 125, 100, 80, 60, or 50 g/l.

These preferences for the primary analyte correspond to preferences for a working pickling and/or brightening solution in some embodiments of the technology disclosed in the patents and patent publication which were above incorporated by reference into this specification. These preferences are based on the fact that the invention described herein is the most practical and economical method known for measuring, and thereby permitting control of, the concentration of iron(III) in these commercially important process liquids.

There are different preferences for the secondary analyte that usually is actually electrolyzed in a process according to this invention. More particularly, a process of eliminating peroxide interference is preferably applied to a secondary analyte that has at least one of the following characteristics:

(A′) a concentration of peroxide, measured as its stoichiometric equivalent as hydrogen peroxide, that is not more than, with increasing preference in the order given, 15, 10, 8, 6, 5.0, 4.0, 3.0, 2.5, 2.3, or 2.1 g/l;

(B′) a concentration of iron(III) that is at least, with increasing preference in the order given, 0.03, 0.05, 0.07, 0.09, 0.11, 0.13, 0.15, 0.17, 0.19, 0.22, or 0.25 g/l;

(C′) a concentration of dissolved fluoride ions, measured as their stoichiometric equivalent as hydrofluoric acid, that is at least, with increasing preference in the order given, 0.05, 0.10, 0.15, 0.20, 0.25, 0.30, 0.33, or 0.35 g/l;

(D′) a ratio of the concentration in g/l of dissolved fluoride ions, measured as their stoichiometric equivalent as hydrofluoric acid, to the concentration of iron(III) that is at least, with increasing preference in the order given, 0.3:1.00, 0.5:1.00, 0.7:1.00, 0.9:1.00, 1.10:1.00, 1.20:1.00, 1.25:1.00, 1.30:1.00, 1.35:1.00, or 1.39:1.00 and preferably is not more than, with increasing preference in the order given, 7.0:1.00, 5.0:1.00, 4.0:1.00, 3.5:1.00, 3.0:1.00, 2.5:1.00, or 2.3:1.00; and

(E′) a concentration of strongly ionized acid that corresponds stoichiometrically, the stoichiometry being based on equal numbers of ionized hydrogen atoms, to a concentration of sulfuric acid that is at least, with increasing preference in the order given, 15, 25, 35, 50, 100, 150, 200, 250, 275, or 300 g/l and preferably is not more than, with increasing preference in the order given, 750, 600, 550, 500, or 450 g/l.

The major identified reason for the preferred upper limits on peroxide concentration is that substantially all the peroxide present must be decomposed by electrolysis before the remainder of the analytical process can proceed, so that more peroxide requires at least one of more current and more time, both of which increasing the cost of the analysis and/or lowering the speed of the analysis. The major identified reason for the preferred lower limits on iron(III) concentration is that the sensitivity of the process may be less than desired if too little iron(III) is present in the secondary analyte. The major identified reason for the preferred concentrations of fluoride ions and ratios of this concentration to iron(III) is that it is known that fluoride complexes Fe⁺³ cations to some extent. Such complexing could affect the electrochemical reactions that occur when the solution is electrolyzed in a manner possibly adverse to the accuracy of the iron(III) determination Finally, the major identified reason for the preference for a very high concentration of strongly ionized acid is that this increases the electrical conductivity of the secondary analyte. Increased electrical conductivity means that less of the electrical energy required for the electrolysis step of the process is wasted by resistance losses through the mixed electrolyte. Because sulfuric acid is usually present in the analyte already and is relatively inexpensive, it is preferably used to provide the additional acidity needed to raise a normal primary analyte to the levels of acidity preferred for a secondary analyte. However, any other sufficiently strongly ionized acid that does not substantially complex iron(III), such as nitric and perchloric acids, could be used instead.

If an analysis process according to the invention is being used to measure the iron(III) concentration in a process solution that needs to be controlled within established limits, it is advantageous to make the analysis itself as fast as is reasonably possible. For this reason, a high current is preferably used during the electrolysis step of a process according to the invention, because a high current will sooner reach the goal of electrolytically destroying the entire peroxide content, at least until the maximum diffusion-limited current density for the oxidation of peroxide is reached. Based on the electroanalytical studies described below, this maximum effective current density appears to be about 0.6 amps per square centimeter of smooth platinum electrode and to be reached at a potential between 1.9 and 2.0 volts more oxidizing than a silver-silver chloride reference electrode. Ordinarily, no harm other than a slight additional cost will result if the actual current density is substantially higher than can be effectively used to oxidize peroxide, because any such excess current density will oxidize water instead and thus will not affect the total amount of iron(III) in the solution. However, if it is readily available, potentiostatic control of the current during electrolysis is preferred in order to minimize the possibility that very high anodic current densities will result in sufficiently high compensating cathodic current densities that begin to reduce iron(III) to iron(II), rather than solely to reduce hydrated protons to hydrogen gas. This phenomenon is believed to underlie the primary cathodic reaction according to the electroanalytical studies described in more detail below.

Any risk of reducing iron(III) to iron(III) in the primary analyte or secondary analyte electrolyzed can be eliminated by conducting the electrolysis in a container divided into two parts by a diffusion barrier that, most preferably, is permeable to hydrogen ions but not to other cations, to any anions, nor to electrons. Less complete diffusion barriers, e.g., sintered glass filters, porous porcelain, and gelled electrolyte solutions, can also be used if the risk of reducing iron(III) is to be lowered, but need not necessarily be totally eliminated. Suitable diffusion barriers of either type are known to those skilled in the art. In practice, however, it has not been found necessary to use any diffusion barrier at all. For convenience and/or economy it is preferred to conduct the electrolysis with both anodic and cathodic electrodes in direct contact with the primary analyte or secondary analyte being electrolyzed.

The material of the electrodes is not believed to be critical to the invention so long as the electrodes do not themselves dissolve as current is passed through them. Platinum and other platinum group metals are most preferred if they are affordable, because they minimize the risk of contamination and generally have low overpotentials for the electrode reactions of interest here. In addition to solid platinum metals, platinized electrodes such as platinized titanium, tantalum, or stainless steel are within a preferred group. Graphite and other conductive carbon electrodes are also suitable.

In order to minimize overpotentials and corresponding consumption of electrical energy, large area electrodes are preferred. Platinum gauze and platinum black-surfaced electrodes are examples of high surface area electrodes that do not necessarily take up much space. In order to minimize voltage requirements further, it is preferred for the anode(s) and cathode(s) to be as close together as reasonably possible. (Suitable precautions should be taken against the possibility that a combustible mixture of hydrogen and oxygen gases may evolve from the container where electrolysis is taking place when the anode(s) and cathode(s) are close together. Ordinarily, the amounts of such gases will be small enough that no serious hazards arise in a well ventilated space.) However, under ordinary conditions of cost of rectified electric current from commercial generators, minimization of voltage requirements is not economically important.

Thus, it has been found that the peroxide content of an aqueous solution containing both peroxide and iron(III) can be destroyed by electrolysis without affecting the iron(III) concentration of the same solution. This is surprising because the standard single electrode potential values for the half reactions listed in Table 1 below would lead one to expect that, as long as the concentration of iron(III) in the solution remains very low, some iron(III) would be reduced (either directly by the cathode or by elemental hydrogen generated there) along with either hydrogen peroxide or water. It has been shown, however, that this does not happen in practice or at least does not happen to a sufficient extent to cause any deviation from the level of precision of the determination of iron(III) needed in practice.

TABLE 1
REDUCING HALF REACTIONS AND CORRESPONDING
STANDARD POTENTIALS

| Half Reaction | E⁰_{red}, Volts |
|---|---|
| 2H⁺ + 2e⁻ → H₂ | 0.000 |
| O₂ + 2H⁺ + 2e⁻ → H₂O₂ | 0.682 |
| Fe⁺³ + e⁻ → Fe⁺² | 0.77 |
| H₂O₂ + 2H⁺ + 2e⁻ → 2H₂O | 1.77 |

ABBREVIATION AND OTHER NOTES FOR TABLE 1
“E⁰_{red}” means “the single electrode potential for the reduction reaction when each substance involved in the reduction reaction is at unit activity”. The values shown are from N. A. Lange, Handbook of Chemistry (Handbook Publishers, Inc., Sandusky, Ohio, 1952), pp. 1246-1249. An explanation of the use of these potentials is given at pages 1243-1244.

The invention and its benefits compared with the prior art may be further appreciated from the following examples.

Electroanalytical Investigations

Test solutions prepared for these investigations are shown in Table 2 below. The balance not shown for each test solution was deionized water.

TABLE 2
COMPOSITIONS OF TEST SOLUTIONS

| | Grams of Ingredient per | | | |
|---|---|---|---|---|
| | Liter of Test Solution Number: | | | |
| Ingredient | 1 | 2 | 3 | 4 |
| h₂SO₄ | 40 | 40 | 40 | 40 |
| HF | 7 | 7 | 7 | 7 |
| H₂O₂ | 0 | 40 | 0 | 40 |
| Iron(III) from | 0 | 0 | 5 | 5 |
| ferric sulfate | | | | |

Potentiodynamic scans of all four of these test solutions were made, using circular working electrodes of smooth platinum with an area of about 1.25 square centimeters each and a silver-silver chloride reference electrode. For all of these test solutions: the rest potential of the working electrodes was about 0.6 volt; scans in the reducing direction showed no current density greater than 0.8 milliamp per square centimeter (“ma/cm²”) at any voltage of the cathodized working electrode less reducing than 0.1 volt and a current density of at least 7 ma/cm² at any voltage of the cathodized working electrode more reducing than −0.4 volt. In Test Solutions 3 and 4, which contained iron(III), there was a detectably higher current density for voltages of the cathodized working electrode between voltages from 0.4 to −0.4 volts than there had been in cathodization of Test Solutions 1 and 2. But the density of this current was so small that it was concluded there was a reasonable expectation that any reduction of iron(III) to iron(II) that might be occurring at the cathodized working electrode was negligible within the limits of accuracy needed for the measurement of iron(III).

### EXAMPLE AND COMPARISON EXAMPLE GROUP 1

Electrolyte of the same composition as Test Solution 4 in Table 2 was analyzed for peroxide content by the following method: a 5.0 milliliter (“ml”) sample of the primary analyte was diluted with deionized water mixed with 5.0 ml of 49% H₂SO₄ to a total of about 100 ml to form a secondary analyte. Then this secondary analyte was titrated with 0.100 N potassium permanganate solution until the color of the titrant was no longer completely cleared by mixing with the analyte, so that the analyte remained faintly pinkish-purplish. The peroxide content in grams in the secondary analyte was calculated as 0.16 times the number of ml of titrant required. (1.6 is one-twentieth of the molecular weight, which equals one-tenth of the redox equivalent weight, of the peroxide moiety —O—O—.) Several replicates of this test produced an average value of 11.7 to 11.8 ml of titrant, corresponding to 0.19 grams of peroxide in the secondary analyte, as expected for a 5 ml sample of a primary analyte that contained 40 g/l of hydrogen peroxide (=38 g/l of peroxide moieties).

Analysis of the iron(III) content was then attempted on other samples of Test Solution 4 by the following method, which is known to be satisfactory in solutions in which iron(III) is the only oxidizing agent: a 5.0 ml sample of the primary analyte was diluted with deionized water and mixed, successively in the order given, with: at least 50 ml of deionized water; 10 ml of a solution of 20 g/l of La(NO₃)₃ in deionized water; 3.0 ml of a solution containing 1000 g/l of potassium iodide in water; 10 ml of 18% hydrochloric acid solution in water; and sufficient additional deionized water to yield a total volume of about 100 ml. A period of 5 minutes was then allowed for the sample to equilibrate. During this period, the mixture was preferably kept in darkness or at most dim light. Iodide ions are oxidized to elemental iodine by the entire content of iron(III). About 1-2 ml of starch indicator solution was then added, and the resulting mixture was then titrated with a 0.100 N solution of sodium thiosulfate until the blue color of iodine-starch complex disappeared from the solution. The content of iron(III) in grams in the secondary analyte was calculated as 0.005585 times the number of ml required in the titration. This result multiplied by 200 should then be the concentration of iron(III) in the primary analyte in g/l.

When this analysis was tried on several samples of Test Solution 4 as described above, widely varying results from the correct 5 g/l up to 25 or more g/l were found. These were interpreted as showing that hydrogen peroxide also can oxidize iodide ions to iodine under the conditions of the analysis and therefore interferes with the determination of iron(III) by this method.

Accordingly, a process of the invention was used to remove this interference. For this purpose, several samples of 5.00 ml each of Test Solution 4 as described above were diluted with water, mixed with 5.0 ml of a solution of 49% sulfuric acid in water, and finally brought to a volume of about 100 ml with additional deionized water. Two platinum gauze cylindrical electrodes, one with a diameter of about 1 centimeter and a length of about 2.5 centimeters and the other with a diameter of about 3 centimeters and a length of about 5 centimeters, were then inserted concentrically with each other into the thus prepared secondary analyte. A current of 3 amps (practical electrical units in which 1 amp≡1 practical coulomb per second) was then passed through the secondary analyte for 20 minutes, with the larger outer electrode as the anodizing (i.e., oxidizing) electrode. The number of coulombs passed through the electrodes was thus (3 coulombs/sec)(20 minutes)(60 seconds per minute)=3.6×10³ coulombs. Test Solution 4 contained 40 g/l of hydrogen peroxide, so that 5.00 ml of Test Solution 4 contained (0.00500)40=0.20 grams of hydrogen peroxide. The equivalent weight (one-half the molecular weight) of hydrogen peroxide is 17.01, so that this amount of hydrogen peroxide constitutes (0.20)/(17.01)=0.0118 equivalents of peroxide. Multiplying by the Faraday constant of 9.65×10⁴ coulombs per equivalent gives 1.13×10³ coulombs required to oxidize all of the hydrogen peroxide. This is smaller than the number of coulombs passed through the solution, so that these steps represent a process according to this invention.

Electrolyzed secondary analyte samples of this type were analyzed for iron(III) by the method described above, except for two modifications: no hydrochloric acid was added, because it was expected that sufficient acidity would be provided by the sulfuric acid already added; and the equilibration period before the titration with thiosulfate was begun was extended to 15 minutes. All of the electrolyzed secondary analyte samples tested by this method gave consistent and accurate results for iron(III) concentrations.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for eliminating the interference of peroxide in an analysis of the concentration of iron(III), within a selected accuracy value and by a selected method with which the presence of peroxide interferes, the process comprising the following steps:
(I) providing an aqueous liquid analyte that contains dissolved iron(III) and dissolved peroxide, the concentration of peroxide being sufficient to interfere with analyzing the concentration of iron(III) within the selected accuracy value by the selected method;
(II) bringing the analyte into contact with one of two electrodes;
(III) causing direct electrical current to flow through the one electrode in an anodizing direction, through the analyte and out of the analyte in a cathodizing direction through the other of the electrodes; and
(IV) continuing the current flow until the concentration of peroxide in the analyte has been reduced to a sufficiently low value that it no longer interferes with determining the concentration of iron(III) by the selected method within the selected accuracy value, thereby forming a peroxide-depleted analyte.

2. The method of claim 1, wherein step (II) comprises:
mixing the analyte with one or more other substances that contain no peroxide or iron(III) to form a secondary analyte.

3. The method of claim 1, wherein step (II) comprises:
mixing the analyte with one or more other substances that contain known amounts of at least one of peroxide and iron(III) to form a secondary analyte.

4. The method of claim 1, wherein step (III) comprises:
providing a diffusion barrier and a distinct liquid electrolyte that is in contact with one of the electrodes with which the analyte is not in contact and that is separated from the analyte by the diffusion barrier; and
causing the direct electrical current to flow therethrough.

5. The method of claim 1, wherein step (IV) further comprises:
continuing the current flow with one or more interruptions; and
determining the peroxide concentration after an interruption so that the consumption of electrical energy is minimized.

6. The method of claim 1, further comprising the steps of:
determining an upper limit on the concentration of peroxide in the analyte electrolyzed in steps (III) and (IV) before beginning the electrolysis; and
continuing the current flow caused in step (III) in step (IV) until an integral of a function of the amount of current flowing through the analyte against time has reached at least a value that corresponds to complete electrolytic consumption of the known upper limit of peroxide in the analyte by oxidizing the oxygen content of the peroxide to elemental oxygen, thereby forming a peroxide-depleted and interference-free analyte.

7. A process according for the analytical determination of iron(III) for removing the interference of peroxide comprising the steps of:
(I) providing an aqueous liquid analyte that contains dissolved iron(III) and dissolved peroxide, the concentration of peroxide being sufficient to interfere with analyzing the concentration of iron(III) within the selected accuracy value by the selected method;
(II) bringing the analyte into contact with one of two electrodes;
(III) causing direct electrical current to flow through the one electrode in an anodizing direction, through the analyte and out of the analyte in a cathodizing direction through the other of the electrodes;
(IV) continuing the current flow until the concentration of peroxide in the analyte has been reduced to a sufficiently low value that it no longer interferes with determining the concentration of iron(III) by the selected method within the selected accuracy value, thereby forming a peroxide-depleted analyte; and
(V) determining the amount of iron(III) in the peroxide-depleted analyte produced in step (IV) by the selected analytical method within the selected accuracy value.

8. The process of claim 7, further comprising the step of:
determining the amount of iron(III) in step (V) by direct titration.

9. The process of claims 1 or 7, wherein the analyte of step (I) comprises a primary analyte, the process further comprising the step of:
mixing the primary analyte with one or more substances that contain no peroxide or iron(III) to form a secondary analyte that is placed in electrical contact with the one electrode.

10. The process of claims 1 or 7, wherein the analyte of step (I) comprises a primary analyte, the process further comprising the step of:
mixing the primary analyte with one or more substances that contain known amounts of at least one of peroxide and iron(III) to form a secondary analyte that is placed in electrical contact with the one electrode.
